(19) United States
(12) Patent Application Publication
(10) Pub. No.: US 2024/0062260 A1
(43) Pub. Date: Feb. 22, 2024

(54) PHOTOVOLTAIC CELL INFORMATION MANAGEMENT SYSTEM

(71) Applicant: TOYOTA JIDOSHA KABUSHIKI KAISHA, Toyota-shi (JP)

(72) Inventors: Taizo MASUDA, Yokohama-shi (JP); Yasunobu SEKI, Nisshin-shi (JP); Hiroki AWANO, Susono-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/328,365

(22) Filed: Jun. 2, 2023

(30) Foreign Application Priority Data
Aug. 22, 2022 (JP) 2022-131965

(51) Int. Cl. G06Q 30/0601; B60L 8/00

(52) U.S. Cl. CPC G06Q 30/0603; G06Q 30/0621; B60L 8/003

(57) ABSTRACT

A supply information registration part for registering supply information including a curvature of a solar cell desired to be supplied by a supplier in a supply information database; A desired information acquisition part for acquiring desired information including a curvature of a solar cell desired to be acquired by a person desired to be acquired; A determination unit for determining whether or not supply information matching the desired information is registered in the supply information database; A photovoltaic cell information management system comprising: a notification unit that notifies at least one of an acquisition request person and a supply request person corresponding to the supply information when the supply information matching the desired information is registered in the supply information database.

### CROSS-REFERENCE TO RELATED APPLICATION

This application claims priority to Japanese Patent Application No. 2022-131965 filed on Aug. 22, 2022, incorporated herein by reference in its entirety.

### BACKGROUND

### 1. Technical Field

The present disclosure relates to a photovoltaic cell information management system.

### 2. Description of Related Art

A system that supports the selling and purchasing of used photovoltaic cells is known.

For example, Japanese Unexamined Patent Application Publication No. 2005-322114 (JP 2005-322114 A) discloses a photovoltaic cell selling/purchasing support system in which a selling product that a selling candidate wishes to sell is compared with product information and installation conditions of a product that a purchasing candidate wishes to purchase, and notifies the purchasing candidate of information on a suitable selling product.

### SUMMARY

In recent years, in-vehicle photovoltaic cells have been widely used. In JP 2005-322114 A described above, the selling product and the product information of the product desired to be purchased are compared by simulation based on the installation conditions such as the shape of the roof, wall, window, and ground on which the photovoltaic cell is installed. However, the technology disclosed in JP 2005-322114 A is premised on the sale and purchase of a photovoltaic cell installed on a flat surface, and it is difficult to match the sale and purchase of a photovoltaic cell installed in a portion having a curvature like a vehicle body.

An object of the present disclosure is to provide a photovoltaic cell information management system that matches a transaction of a photovoltaic cell installed at a portion having a curvature.

One aspect for achieving the above object is
a photovoltaic cell information management system including:
a supply information registration unit that registers in a supply information database, supply information including a curvature of a photovoltaic cell that a supply candidate wishes to supply from;
a desired information acquisition unit that acquires desired information including a curvature of a photovoltaic cell that an acquisition candidate wishes to acquire;
a determination unit that determines whether supply information corresponding to the desired information is registered in the supply information database; and
a notification unit that notifies at least one of the acquisition candidate and the supply candidate corresponding to the supply information when the supply information corresponding to the desired information is registered in the supply information database.

According to the present disclosure, it is possible to provide a photovoltaic cell information management system that matches a transaction of a photovoltaic cell installed in a portion having a curvature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an outline of a photovoltaic cell information management system according to an embodiment;

FIG. 2 is a flowchart illustrating a flow of the photovoltaic cell information management method according to the embodiment;

FIG. 3 is a flowchart illustrating a flow of a matching determination process for registered desired information.

### DETAILED DESCRIPTION OF EMBODIMENTS

Hereinafter, embodiments of the present disclosure will be described in detail with reference to the drawings. In each drawing, the same or corresponding elements are designated by the same reference signs, and duplicate descriptions are omitted as necessary for the sake of clarity.

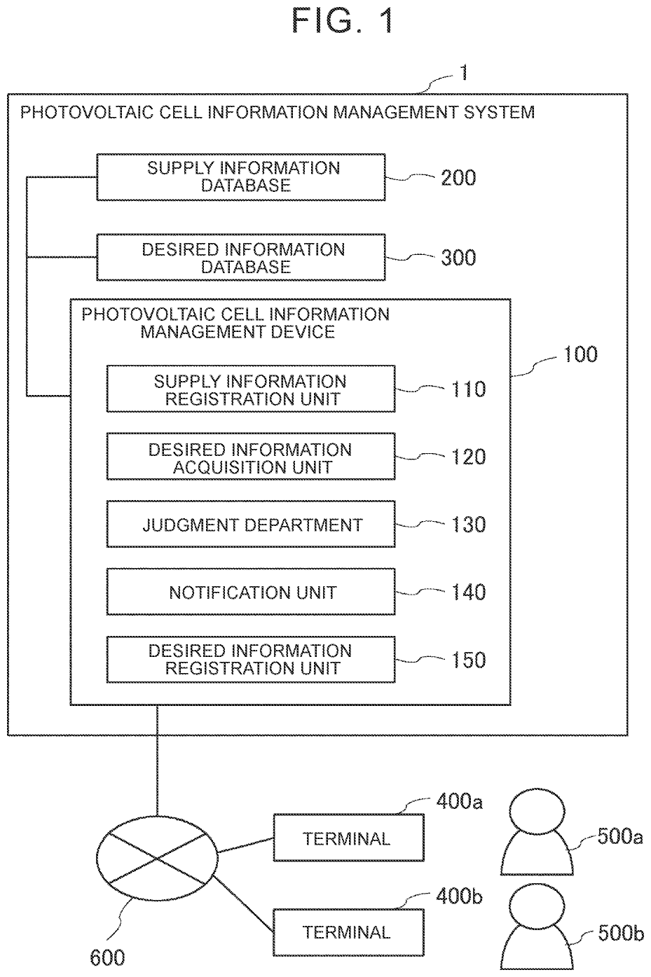

FIG. 1 is a block diagram illustrating an outline of a photovoltaic cell information management system 1 according to an embodiment. The photovoltaic cell information management system 1 is a system that manages information of used photovoltaic cells and performs matching between a supplier and an acquisition applicant. The photovoltaic cell information management system 1 is preferably used when managing information of used in-vehicle photovoltaic cells. The photovoltaic cell information management system 1 includes a photovoltaic cell information management device 100, a supply information database 200, and a desired information database 300. The photovoltaic cell information management system 1 is communicably connected to a terminal 400 (400a, 400b) via a network 600. The network 600 is a wired or wireless communication line, and may include the Internet. The number of terminals 400 connected to the photovoltaic cell information management system 1 may be three or more.

The terminal 400 (400a, 400b) is a communication terminal operable by the user 500 (500a, 500b). The terminal 400 is, for example, an information processing apparatus having a wireless communication function such as a mobile phone, a smartphone, or a tablet terminal. The terminal 400 includes an input device, a display device, and a computer as a hardware configuration.

In the embodiment illustrated in FIG. 1, the user 500a operates the terminal 400a. The user 500a is the supplier wish. Hereinafter, the user 500a may be referred to as a supply candidate 500a. The supplier is a user who wishes to supply used photovoltaics. The supply candidate 500a operates an input device included in the terminal 400a to input supply information regarding a used photovoltaic cell desired to be supplied. The input supply information is transmitted to the photovoltaic cell information management device 100 via the network 600. When the supply information is transmitted, the supply information is transmitted to the photovoltaic cell information management device 100 along with the information on the contact address of the supply candidate 500a. The information regarding the contact of the supply candidate 500a may be, for example, information identifying the terminal 400a or a mail address of the supply candidate 500a. In addition, upon receiving the notification from the photovoltaic cell information management device 100 via the network 600, the display device included in the terminal 400a displays the received notification.

Further, in the embodiment illustrated in FIG. 1, the user 500b operates the terminal 400b. The user 500b is a person who wishes to acquire. Hereinafter, the user 500b may be referred to as “acquisition candidate 500b”. The person who wants to acquire is a user who wants to acquire a used photovoltaic cell. The acquisition candidate 500b operates an input device included in the terminal 400b and inputs desired information regarding a used photovoltaic cell that is desired to be acquired. The input desired information is transmitted to the photovoltaic cell information management device 100 via the network 600. When the desired information is transmitted, the information on the contact address of acquisition candidate 500b of the person who wishes to acquire is attached to the photovoltaic cell information management device 100. The information regarding the contact of the acquisition candidate 500b may be, for example, information identifying the terminal 400b, or a mail address of the acquisition candidate 500b. In addition, upon receiving the notification from the photovoltaic cell information management device 100 via the network 600, the display device included in the terminal 400b displays the received notification.

The supply info includes the curvature of the used photovoltaic cell that the supply candidate 500a wishes to supply. In addition, the desired data includes the curvature of the used photovoltaic cell that the acquisition candidate 500b desires to acquire. In-vehicle solar cells are installed, for example, on a roof of an automobile. The roof of the motor vehicle has a curvature in the three-dimensional direction. Specifically, the roof of the automobile has curvature in the front-rear direction and the width direction of the automobile. The front-rear direction of the automobile is a starting direction of the automobile. The width direction of the automobile is a direction perpendicular to the starting direction and the vertical direction of the automobile.

Installation of photovoltaic cells formed along the three-dimensional curvature of the roof of an automobile can cover a large area on the roof of an automobile using a small number of photovoltaic cells. That is, by installing a photovoltaic cell having a curvature in a three-dimensional direction along the roof of an automobile, the efficiency of photovoltaic power generation can be improved. In the photovoltaic cell information management system 1, since the used photovoltaic cells are matched based on the supply information including the curvature and the desired information, the acquisition candidate 500b can acquire the photovoltaic cells matching the curvature of the roof of the vehicle that is desired to be installed.

The supply information and the desired information may further include at least one of information on power generation, information on area, price, and information on an installation location. The information related to the power generation is information related to the power generation amount of the photovoltaic cell, and is, for example, a power generation capacity, a power generation efficiency, and the like. The area is the footprint of the solar cell. The information on the price is information on the transaction price of the photovoltaic cell, and is, for example, a sales price desired by the supply candidate 500a. The information on the installation location is information on the location where the solar cell is installed, and is, for example, the curvature of the location where the solar cell is installed. When the photovoltaic cell is an on-vehicle photovoltaic cell, the information on the installation location is information on the installation vehicle. The information on the installed vehicle is information on the vehicle in which the solar cell is installed, and is, for example, information on the vehicle type of the installed vehicle. When the supply information and the desired information include at least one of the information on the power generation, the information on the area, the price, and the information on the installation location, the photovoltaic cell information management system 1 can perform matching according to the desires of the supply desire and the acquisition desire.

The photovoltaic cell information management device 100 is an information processing device that manages information acquired from the terminal 400, matches supply information with desired information, notifies matching information, and the like, and is, for example, a server device realized by a computer. The photovoltaic cell information management device 100 may be redundant in a plurality of servers, and each functional block may be realized by a plurality of computers. As illustrated in FIG. 1, the photovoltaic cell information management device 100 may include at least a supply information registration unit 110, a desired information acquisition unit 120, a determination unit 130, and a notification unit 140, and may further include a desired information registration unit 150.

Upon receiving the supply information from the terminal 400a, the supply information registration unit 110 registers the received supply information in the supply information database 200 in association with the information on the contact of the supply candidate 500a. The supply information database 200 is a database that stores supply information and information on a contact address of a supply requester who has input the supply information in association with each other. The supply information database 200 usually stores a plurality of supply information.

The desired information acquisition unit 120 receives the desired information from the terminal 400b, and acquires the desired information and the information related to the contact of acquisition candidate 500b of the person who wants to acquire. The determination unit 130 compares the desired information acquired by the desired information acquisition unit 120 with the supply information registered in the supply information database 200, and determines whether or not the supply information matching the desired information is registered in the supply information database 200.

When the supply information matching the desired information is registered in the supply information database 200, the notification unit 140 notifies at least one of the acquisition request person and the supply request person corresponding to the supply information. The notification unit 140 notifies the acquisition request person based on the information about the contact of the acquisition request person. The notification unit 140 notifies the supply requester based on the information on the contact address of the supply requester associated with the supply information matching the desired information. The notification from the notification unit 140 to the acquisition request person and the supply request person is performed, for example, by the notification unit 140 transmitting a notification to the terminal 400. In addition, in a case where the information on the contact address of the person who wants to acquire and the information on the contact address of the person who wants to supply are the mail addresses, the notification unit 140 may transmit the mail including the notification content to the mail address.

When the supply information matching the desired information is not registered in the supply information database 200, the desired information registration unit 150 associates the desired information with the information regarding the contact of the acquisition request person and registers the information in the desired information database 300.

The photovoltaic cell information management device 100 includes a processor, a memory, and a storage device as a configuration (not shown). Further, the storage device stores a computer program on which the process of the photovoltaic cell information management method according to the present embodiment is implemented. The processor reads the computer program from the storage device into the memory and executes the computer program. Thus, the processor implements the functions of the supply information registration unit 110, the desired information acquisition unit 120, the determination unit 130, the notification unit 140, and the desired information registration unit 150.

Further, each of the supply information registration unit 110, the desired information acquisition unit 120, the determination unit 130, the notification unit 140, and the desired information registration unit 150 may be realized by dedicated hardware. In addition, some or all of the constituent elements of the respective apparatuses may be realized by a general-purpose or dedicated circuitry, a processor, or the like, or a combination thereof. These may be constituted by a single chip, or may be constituted by a plurality of chips connected via a bus. Some or all of the constituent elements of each device may be realized by a combination of the above-described circuit or the like and a program. Further, as the processor, Central Processing Unit (CPU), Graphics Processing Unit (GPU), field-programmable gate array (FPGA), and the like can be used.

In addition, when some or all of the constituent elements of the photovoltaic cell information management device 100 are realized by a plurality of information processing apparatuses, circuits, or the like, the plurality of information processing apparatuses, circuits, or the like may be centrally arranged or distributed. For example, the information processing apparatus, the circuit, and the like may be realized as a form in which each of the client server system, the cloud computing system, and the like is connected via a communication network. In addition, the functions of the photovoltaic cell information management device 100 may be provided in the form of Software as a Service (SaaS).

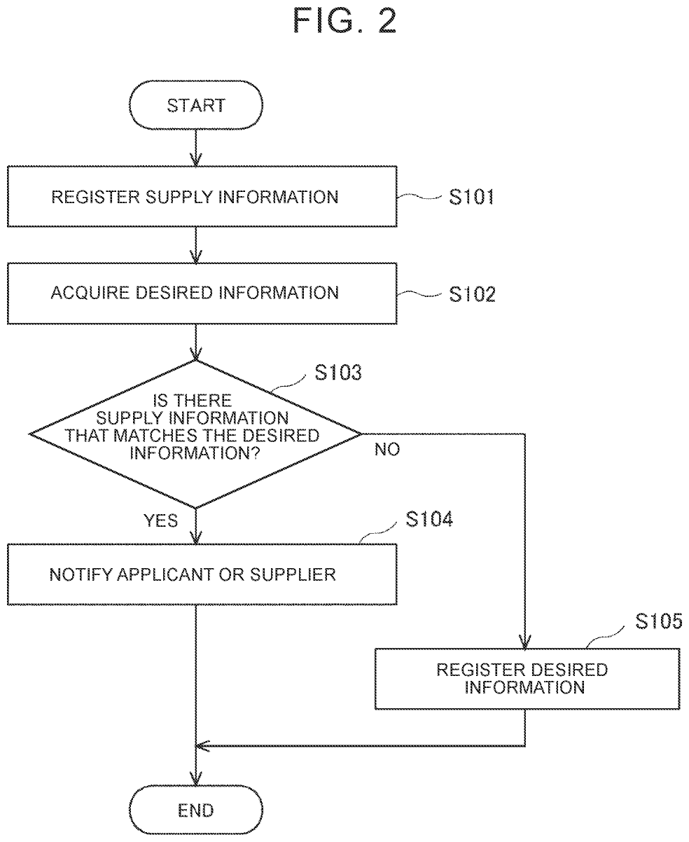

Next, an operation example of the photovoltaic cell information management device 100 will be described with reference to FIG. 2. FIG. 2 is a flowchart showing a flow of a photovoltaic cell information management method (photovoltaic cell information management method according to the embodiment) performed using the photovoltaic cell information management device 100. First, the supply information registration unit 110 registers the supply information including the curvature of the photovoltaic cell that the supply requester desires to supply in the supply information database (S101). Next, the desired information acquisition unit 120 acquires desired information including the curvature of the photovoltaic cell desired to be acquired by the acquirer (S102). The determination unit 130 determines whether or not the supply information matching the desired information acquired in S102 is registered in the supply information database 200 (S103). When the supply information matching the desired information is registered in the supply information database 200 (S103Yes), the notification unit 140 notifies at least one of the acquisition request person and the supply request person corresponding to the supply information (S104). When the supply information matching the desired information is not registered in the supply information database 200 (S103No), the desired information registration unit 150 registers the desired information in the desired information database 300 (S105).

As described above, in the photovoltaic cell information management method according to the embodiment, based on the supply information including the curvature of the photovoltaic cell, it is determined whether or not the supply information matching the photovoltaic cell desired to be acquired by the person who wants to acquire is registered in the supply information database. Therefore, it is possible to perform matching of the photovoltaic cells installed at the places having the curvature.

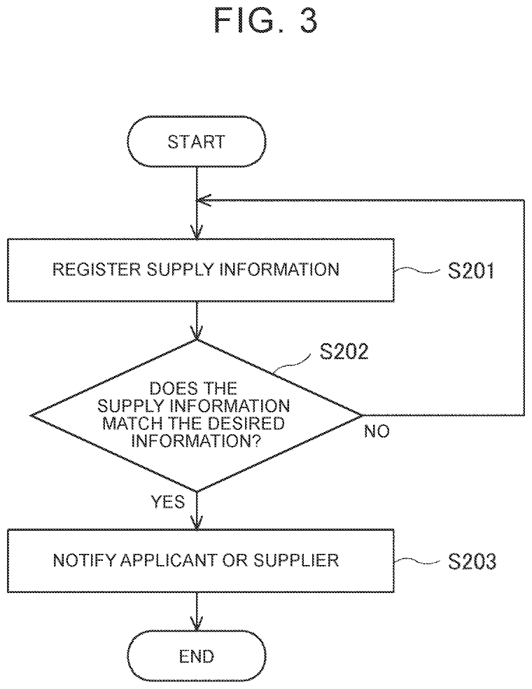

Next, an operation example of the photovoltaic cell information management device 100 after the desired information is registered in the desired information database 300 will be described with reference to FIG. 3. FIG. 3 is a flowchart illustrating a flow of a matching determination process for registered desired information. Upon receiving the new supply information, the supply information registration unit 110 registers the received supply information in the supply information database 200 (S201). The determination unit 130 determines whether or not the supplied information registered in S201 matches the desired information registered in the desired information database 300 (S202). When the supply information matches the desired information (S202Yes), the notification unit 140 notifies at least one of the acquisition-desired person and the supply-desired person corresponding to the supply information (S203). As described above, the photovoltaic cell information management system 1 may register the desired information when the supply information matching the desired information is not registered, and perform matching each time the new supply information is registered.

The present disclosure contributes to decarbonization, carbon neutral, and Sustainable Development Goals (SDGs, as well as sustainable developmental goals, by promoting the popularization and reuse of photovoltaic cells. Note that, the present disclosure is not limited to the above embodiments, and can be appropriately modified without departing from the spirit. Further, the present disclosure may be implemented by appropriately combining the respective embodiments.

What is claimed is:

1. A photovoltaic cell information management system comprising:
a supply information registration unit that registers in a supply information database, supply information including a curvature of a photovoltaic cell that a supply candidate wishes to supply from;
a desired information acquisition unit that acquires desired information including a curvature of a photovoltaic cell that an acquisition candidate wishes to acquire;
a determination unit that determines whether supply information corresponding to the desired information is registered in the supply information database; and
a notification unit that notifies at least one of the acquisition candidate and the supply candidate corresponding to the supply information when the supply information corresponding to the desired information is registered in the supply information database.

2. The photovoltaic cell information management system according to claim 1, further comprising a desired information registration unit that registers, in a desired information database, the desired information that is input, when supply information corresponding to the desired information is not registered in the desired information database.

3. The photovoltaic cell information management system according to claim 1, wherein the supply information and the desired information further includes at least one of information on power generation, information on an area and a price, and information on an installation location.

4. The photovoltaic cell information management system according to claim 3, wherein:
the photovoltaic cell is an in-vehicle photovoltaic cell; and
the information on the installation location is information on a vehicle in which the photovoltaic cell is installed.

5. The photovoltaic cell information management system according to claim 1, wherein the curvature is a three-dimensional curvature.
